(19) United States
(12) Patent Application Publication
(10) Pub. No.: US 2018/0093208 A1
(43) Pub. Date: Apr. 5, 2018

(54) FILTER DEVICE

(71) Applicant: YAMASHIN-FILTER CORP., Kanagawa (JP)

(72) Inventor: Kenji Tachibana, Kanagawa (JP)

(21) Appl. No.: 15/820,321

(22) Filed: Nov. 21, 2017

Related U.S. Application Data
(63) Continuation of application No. PCT/JP2016/066182, filed on Jun. 1, 2016.

(30) Foreign Application Priority Data
Jun. 2, 2015 (JP) 2015-112563

(51) Int. Cl. B01D 27/08

(52) U.S. Cl. CPC B01D 27/08

(57) ABSTRACT

A component that may not function properly when being removed from a case can be easily attached to the case and can be prevented from being removed from the case. When a substantially cylindrical inner tube is inserted into a case, a substantially cylindrical receiving part provided with claws is inserted along the inner tube, and the claws lock into the hole. When a filter element is inserted into the case, the inner tube is inserted along the inner peripheral surface of a filtration material, and an end member is inserted along a receiving part.

### CROSS-REFERENCE TO RELATED APPLICATIONS

The present application is a continuation application of International Patent Application No. PCT/JP2016/066182 filed on Jun. 1, 2016, which claims priority to Japanese Patent Application No. 2015-112563 filed on Jun. 2, 2015, the entire contents of which are incorporated by reference.

### TECHNICAL FIELD

The present invention relates to a filter device.

### BACKGROUND ART

Patent Document 1 discloses a filter device in which at least one of retaining elements at least partially composes a screw part and has a shape concentric with the longitudinal axial line of a filter housing, and in which a filter element rotates about a longitudinal axial line thereof and is then fixed by interlock connection.

### CITATION LIST

### Patent Literature

Patent Literature 1: JP 2005-502450 A

In the invention disclosed in Patent Document 1, the filter element is fixed by a screw. Since the filter element is required to be removed, it is appropriate that the filter element is attached to a filter housing (hereinafter referred to as “case”) by a screw as described in Patent Document 1. However, the filter device may include a component, other than the filter element, that may not function properly when being removed from the case.

In a case where such a component that may not function properly when being removed from the case is attached to the case by a screw, when the component is being removed from the case, the filter device may not function normally. Thus, the method of fixing a component by a screw, described in Patent Document 1, cannot be employed for such a component.

In the light of the foregoing, an object of the present invention is to provide a filter device in which a component that may not function properly when being removed from a case can be easily attached to the case and can be prevented from being removed from the case.

### SUMMARY OF INVENTION

A filter device according to an aspect of the present invention includes, for example: a case having a bottomed substantially cylindrical shape; an inner tube having a substantially cylindrical shape; and a filter element including a filtration material having a substantially cylindrical shape and a first end member disposed at a first end of the filtration material. The case has a bottom surface provided with a first receiving part and a second receiving part, the first receiving part having a substantially cylindrical shape and being provided with claws, and the second receiving part being formed outside the first receiving part. The inner tube is provided with a hole for locking the claws thereinto. Upon insertion of the inner tube into the case, the first receiving part is inserted along the inner tube, and the claws lock into the hole, so that the inner tube is attached to the case. Upon insertion of the filter element into the case, the inner tube is inserted along inner peripheral surfaces of the filtration material and the first end member, and the first end member is inserted between the second receiving part and the inner tube.

In the filter device according to the aspects of the present invention, when the substantially cylindrical inner tube is inserted into the case, the substantially cylindrical first receiving part provided with the claws is inserted along the inner tube, and the claws lock into the hole. In this way, a component (here, the inner tube) can be easily attached to the case. Since the claws lock into the hole, the component (here, the inner tube) can be prevented from being removed from the case.

Here, the claws may be formed protruding outward in a radial direction. The second receiving part may include a first tube portion, a flange portion, and a second tube portion. The first tube portion is formed outside the first receiving part, having a diameter greater than a diameter of the first receiving part, and being higher than the first receiving part. The flange portion has a substantially circular plate shape and is formed at an end, of the first tube portion, on a side opposite to a side coming into contact with the bottom surface of the case. The second tube portion is formed along an outer peripheral surface of the flange portion, protruding toward a side where the first tube portion is not formed, and has a diameter greater than the diameter of the first tube portion. The inner tube may be inserted between the first receiving part and the first tube portion, and the first end member may be inserted along an inner peripheral surface of the second tube portion. The claws and the hole are covered by the first tube portion and the flange portion such that the claws cannot be pressed with a tool or the like. Thus, the inner tube can be prevented from being removed from the case.

Here, the filter element may include a second end member disposed at a second end of the filtration material, the second end being an end other than the first end. The inner tube may have an outer peripheral surface provided with protrusions formed in a longitudinal direction, protruding outward in the diameter direction; and the first end member and the second end member each may be provided with recessed portions for locking the protrusions thereinto. This configuration enables the filter element to be positioned relative to the inner tube in a rotational direction.

Here, the protrusions may include, in a plane orthogonal to a center axis of the inner tube: two first protrusions formed on a first line passing through the center axis of the inner tube, the first protrusions facing each other across the center axis of the inner tube; a second protrusion formed on a second line passing through the center axis of the inner tube, the second line being orthogonal to the first line; and a third protrusion formed on a third line turned about the center axis of the inner tube from the second line by a first angle, the third protrusion facing the second protrusion across the center axis of the inner tube. This configuration can prevent an imitation from being attached.

Here, a center axis of the first end member and the second tube portion may be shifted in position in a radial direction with respect to the center axis of the inner tube and the first tube portion. This configuration can prevent an imitation from being attached.

According to the aspects of the present invention, a component that may not function properly when being removed from the case can be easily attached to the case and can be prevented from being removed from the case.

### BRIEF DESCRIPTION OF DRAWINGS

FIG. 1 is a perspective view illustrating an overview of a filter device 1 of a first embodiment of the present invention.

FIG. 2 is a perspective view for describing a receiving part 11b and a receiving part 12 formed on a bottom surface 11a of a case 11.

FIG. 3 is a perspective view illustrating an overview of an inner tube 20.

FIG. 4 is a perspective view illustrating a state in which the inner tube 20 is placed between the receiving part 11b and the receiving part 12, that is, in the case 11.

FIG. 5 is a view, in a +z direction, of the state illustrated in FIG. 4.

FIG. 6 is a view of an upper end member 32 from the filtration material 31 side (−z side).

FIG. 7 is a view of a lower end member 33 from a side (−z side) opposite to the filtration material 31 side.

FIG. 8 is a cross-sectional view of the filter device 1.

FIG. 9 is a cross-sectional view of the filter device 1.

FIG. 10 is a perspective view illustrating an overview of a filter device 2 of a second embodiment of the present invention.

### DESCRIPTION OF EMBODIMENTS

Embodiments of the present invention will be described in detail below with reference to the drawings.

### First Embodiment

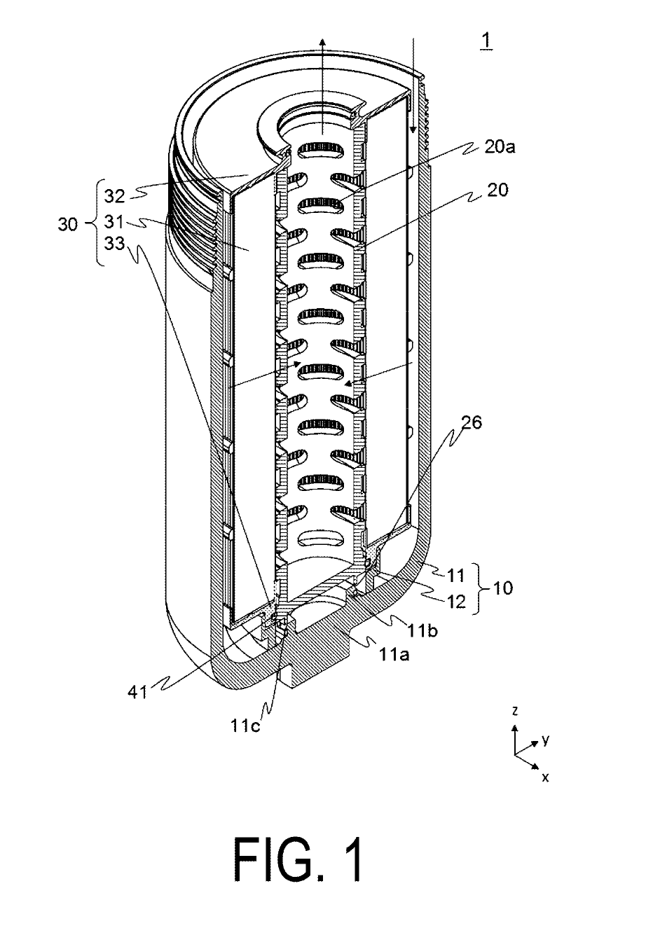

FIG. 1 is a perspective view illustrating an overview of a filter device 1. The filter device 1 filters liquid, such as oil, and mainly includes a case assembly 10, an inner tube 20, and a filter element 30. In FIG. 1, the filter device 1 is cut along a yz plane for description.

The case assembly 10 mainly includes a case 11 and a receiving part 12. For example, the case 11 is made of metal, and the receiving part 12 is made of resin (for example, PA6).

The case 11 has a bottomed substantially cylindrical shape, and includes a bottom surface 11a. A receiving part 11b protruding inward (in the +z direction) is formed on the bottom surface 11a. In the present embodiment, the receiving part 11b is formed integrally with the bottom surface 11a; however, the receiving part 11b may be a member separated from the case 11, and the receiving part 11b may be integrated with the bottom surface 11a by welding or the like.

The receiving part 12 protruding inward (in the +z direction) is formed on the bottom surface 11a of the case 11. In the present embodiment, the case 11 and the receiving part 12 are separate members, and the receiving part 12 is integrated with the case 11 by welding or the like. However, the case 11 and the receiving part 12 may be a single member.

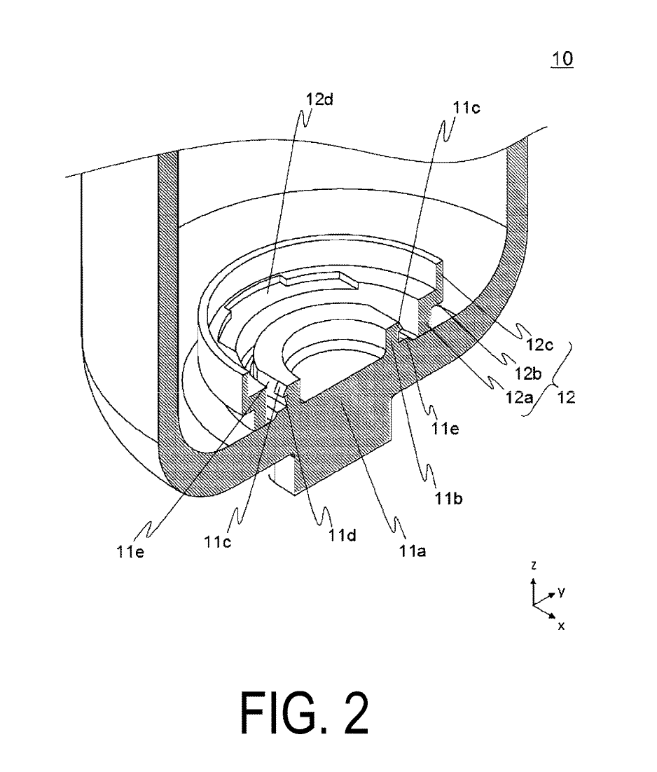

FIG. 2 is a perspective view for describing the receiving part 11b and the receiving part 12 formed on the bottom surface 11a of the case 11. In FIG. 2, similar to FIG. 1, the case 11 is cut along the yz plane.

The receiving part 11b has a substantially cylindrical shape and is provided with claws 11c formed in two positions facing each other. In the present embodiment, the claws 11c are formed in the two positions at an end in a +y direction and an end in a −y direction; however, the positions and number of the claws 11c are not limited to this configuration. For example, three claws 11c may be provided at intervals of 60 degrees.

The claws 11c are formed on the outer peripheral surface of the receiving part 11b and protrude outward. The shape of the claws 11c in an xy plane is substantially triangular. The claws 11c each have a flat surface 11d substantially parallel with the xy plane, on the side opposite to the side the inner tube 20 is inserted, that is, on the bottom surface side (−z side).

In the present embodiment, the receiving part 11b has flat surfaces 11e formed parallel with an xz plane, and the claws 11c are formed on the flat surfaces 11e. However, the flat surfaces 11e are not essential.

The receiving part 12 has a substantially cylindrical shape as a whole and mainly includes a tube portion 12a, a flange portion 12b, and a tube portion 12c.

The tube portion 12a has a substantially cylindrical shape and is formed outside the receiving part 11b. The tube portion 12a has a diameter greater than a diameter of the receiving part 11b and is higher (in the z direction) than the receiving part 11b.

The flange portion 12b has a substantially circular plate shape and is formed at the end on a +z side of the tube portion 12a (the end on the side opposite to the side coming into contact with the bottom surface 11a). The upper surface (surface on the +z side) of the flange portion 12b is substantially parallel with the xy plane. The inner peripheral surface of the flange portion 12b and the inner peripheral surface of the tube portion 12a are in the same plane. The outer peripheral surface of the flange portion 12b and the outer peripheral surface of the tube portion 12c are in the same plane.

Recessed portions 12d are formed on the upper surface (surface on the +z side) of the flange portion 12b and come into contact with a flange portion 23 (described later) of the inner tube 20.

The tube portion 12c is formed along the outer peripheral surface of the flange portion 12b and protrudes from the flange portion 12b in the +z direction (toward the side where the tube portion 12a is not formed). The tube portion 12c has a diameter greater than the diameter of the tube portion 12a.

The description will now return to FIG. 1. The inner tube 20 has a substantially cylindrical shape and is provided with a plurality of holes 20a through which filtered liquid passes. In the present embodiment, the inner tube 20 is made of resin but the inner tube 20 may be made of metal.

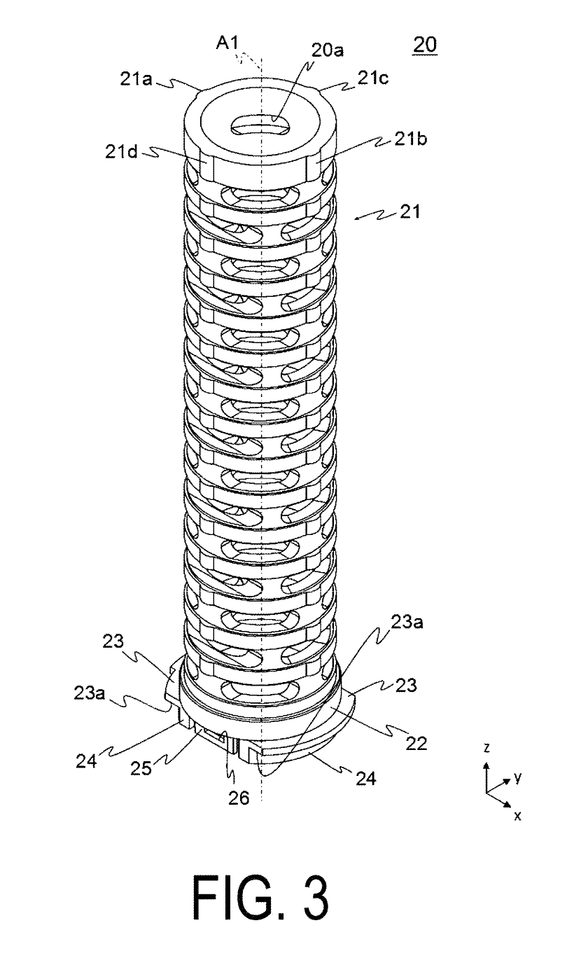

FIG. 3 is a perspective view illustrating an overview of the inner tube 20. The inner tube 20 has a substantially cylindrical shape as a whole and mainly includes a main body portion 21, a cylindrical portion 22, the flange portion 23, a cylindrical portion 24, a plate portion 25, and a hole 26.

The main body portion 21 has a substantially cylindrical shape and is provided with the plurality of holes 20a formed penetrating in the radial direction. Protrusions 21a, 21b, 21c. 21d (described later) are formed in the longitudinal direction on the outer peripheral surface of the main body portion 21 and protrude outward in the radial direction.

The cylindrical portion 22 has a substantially cylindrical shape and is formed on one end (here, the end on the −z side) of the main body portion 21. The cylindrical portion 22 comes into contact with the filter element 30.

The flange portion 23 has a substantially circular plate shape and is formed on one end (here, the end on the −z side) of the cylindrical portion 22. A bottom surface 23a is a surface on the lower side (−z side) of the flange portion 23 that comes into contact with the recessed portions 12d.

The cylindrical portion 24 has a substantially cylindrical shape and is formed protruding in a −z direction from an end surface of the flange portion 23. The inner peripheral surface of the cylindrical portion 24 comes into contact with the outer peripheral surface of the receiving part 11b.

The plate portion 25 is disposed adjacent to the cylindrical portion 24. The inner surface of the plate portion 25 comes into contact with the flat surfaces 11e. The plate portion 25 is provided with the hole 26 formed in a direction orthogonal to a center axis A1 of the inner tube 20. In the present embodiment, the hole 26 is formed in the ±y direction.

The claws 11c are inserted into the hole 26. The hole 26 is formed substantially at a center of the plate portion 25, that is, in the vicinity of an end section of the inner tube 20.

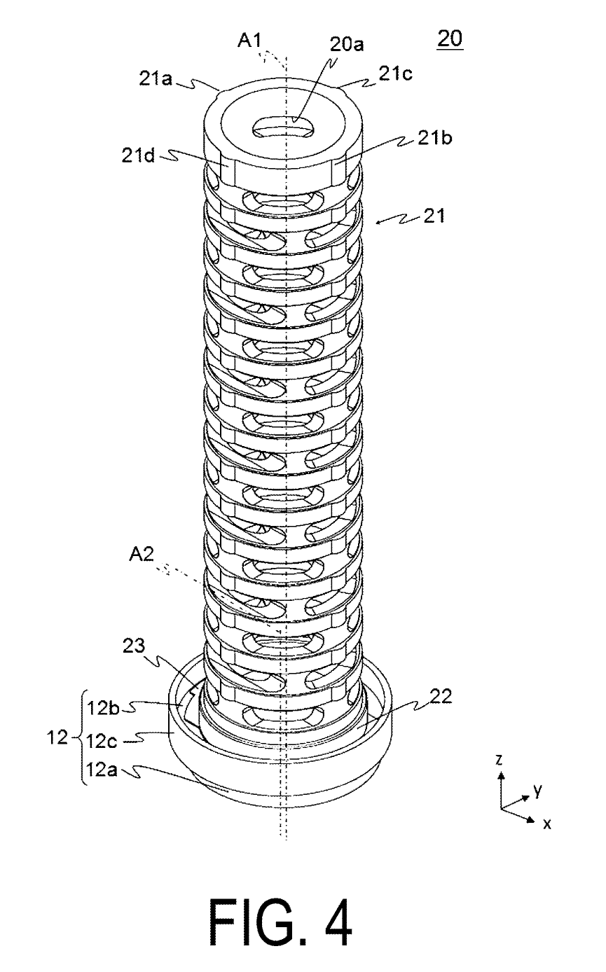

FIG. 4 is a perspective view illustrating a state in which the inner tube 20 is placed between the receiving part 11b and the receiving part 12, that is, in the case 11. In FIG. 4, the case 11 is omitted.

When the cylindrical portion 24 and the plate portion 25 are inserted between the receiving part 11b and the tube portion 12c (described later and not illustrated in FIG. 4), the bottom surface 23a of the flange portion 23 comes into contact with the recessed portions 12d, and the claws 11c lock into the hole 26 (described later and not illustrated in FIG. 4). In this way, the inner tube 20 is placed in the case 11.

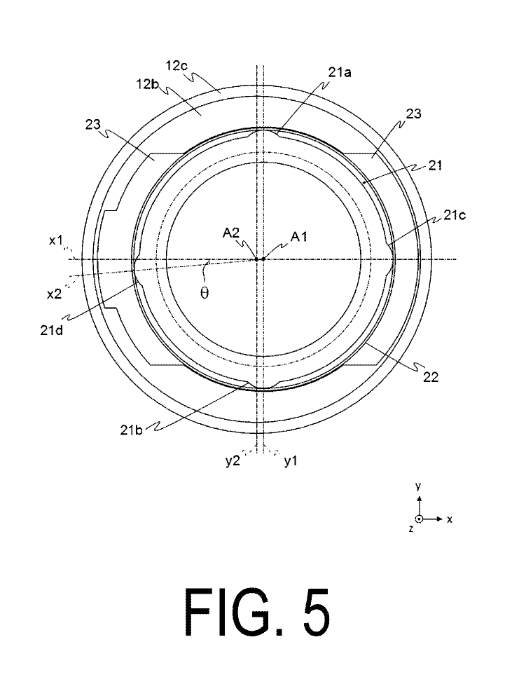

FIG. 5 is a view, in the +z direction, of the state illustrated in FIG. 4, in which the inner tube 20 is placed in the case 11.

The protrusions 21a, 21b are formed on a line y1 that passes through the center axis A1 of the inner tube 20 and that is substantially parallel with the y direction, in a plane substantially parallel with the xy plane. The protrusions 21a, 21b are formed facing each other across the center axis A1.

The protrusion 21c is formed on a line x1 that passes through the center axis A1 of the inner tube 20 and that is substantially parallel with the x direction, in the plane substantially parallel with the xy plane.

The protrusion 21d is formed on a line x2 that is turned counterclockwise about the center axis A1 from the line x1 by an angle θ, viewed in the +z direction, in the plane substantially parallel with the xy plane. In the present embodiment, the angle θ formed between the line x1 and the line x2 is approximately 5 degrees; however, no such limitation is intended. For example, the angle θ may be any angle 10 degrees or less.

The centers of the main body portion 21 and the cylindrical portion 22 coincide with the center axis A1 of the inner tube 20. However, the center of the tube portion 12c coincides with a center axis A2. The center axis A2 is shifted in the radial direction, herein a −x direction, with respect to the center axis A1.

The description will now return to FIG. 1. The filter element 30 mainly includes a filtration material 31, an upper end member 32, and a lower end member 33.

The filtration material 31 has a substantially cylindrical shape and is formed by folding a resin thin plate into a pleated shape, for example. The upper end member 32 is disposed at the upper end (the end on the +z side) of the filtration material 31, and the lower end member 33 is disposed at the lower end (the end on the −z side) of the filtration material 31. The upper end member 32 and the lower end member 33 are made of resin and have substantially cylindrical ribs covering the inner peripheral surface and outer peripheral surface of the filtration material 31. The upper end member 32 and the lower end member 33 are provided covering end sections of the filtration material 31.

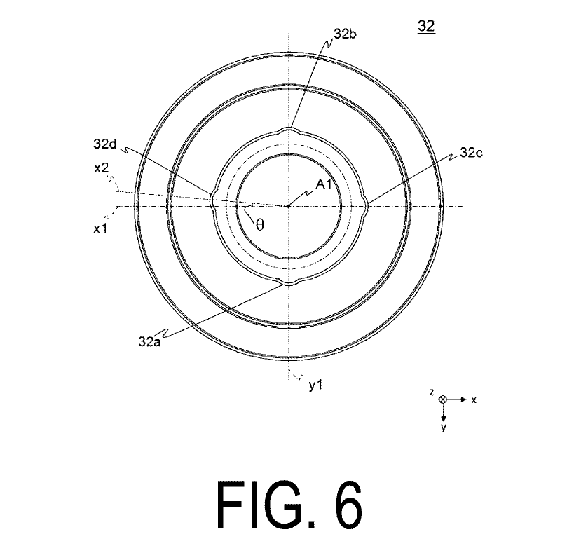

FIG. 6 is a view of the upper end member 32 from the filtration material 31 side (−z side). The upper end member 32 has a substantially cylindrical shape having a center axis coinciding with the center axis A1. The upper end member 32 is provided with recessed portions 32a, 32b, 32c. 32d for locking the protrusions 21a, 21b, 21c, 21d thereinto.

The recessed portions 32a, 32b are for locking the protrusions 21a, 21b thereinto. The recessed portions 32a, 32b are formed on the line y1. The recessed portion 32c is for locking the protrusion 21c thereinto. The recessed portion 32c is formed on the line x1. The recessed portion 32d is for locking the protrusion 21d thereinto. The recessed portion 32d is formed on the line x2. The line x2 is turned clockwise about the center axis A1 from the line x1 by the angle θ, viewed in the −z direction.

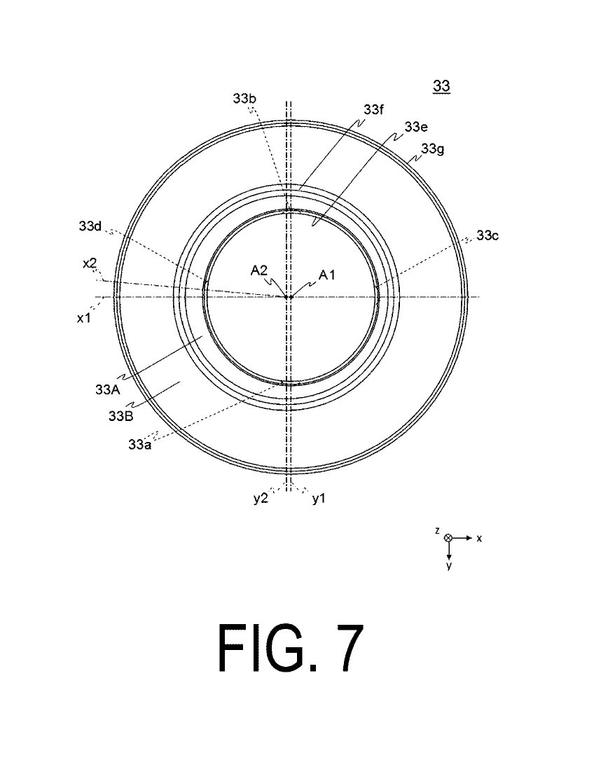

FIG. 7 is a view of the lower end member 33 from the side (−z side) opposite to the filtration material 31 side. The lower end member 33 mainly includes a rib 33A and a flange portion 33B.

The rib 33A has an inner peripheral surface 33e that is a substantially cylindrical surface having a center coinciding with the center axis A1. The cylindrical portion 22 of the inner tube 20 is inserted on the inner side of the inner peripheral surface 33e. The rib 33A has an outer peripheral surface 33f that is a substantially cylindrical surface having a center axis coinciding with the center axis A2. The outer peripheral surface 33f is inserted into the tube portion 12c. Similar to the outer peripheral surface 33f, an outer peripheral surface 33 g covering the outer peripheral surface of the filtration material 31 is also a substantially cylindrical surface having a center axis coinciding with the center axis A2.

The lower end member 33 is provided with recessed portions 33a, 33b, 33c, 33d for locking the protrusions 21a, 21b, 21c, 21d thereinto. The recessed portions 32a, 32b, 32c, 32d and the recessed portions 33a, 33b, 33c, 33d are in the same positions in a plane substantially parallel with the xy plane.

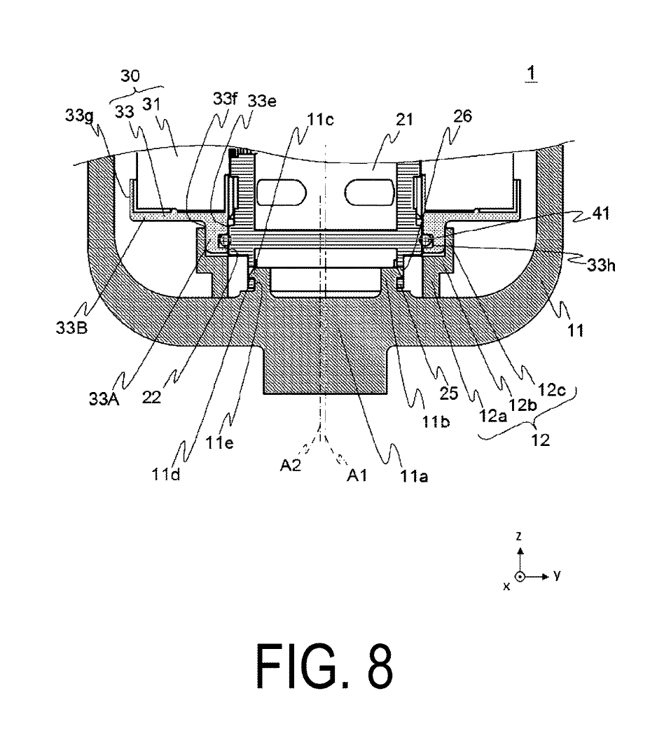

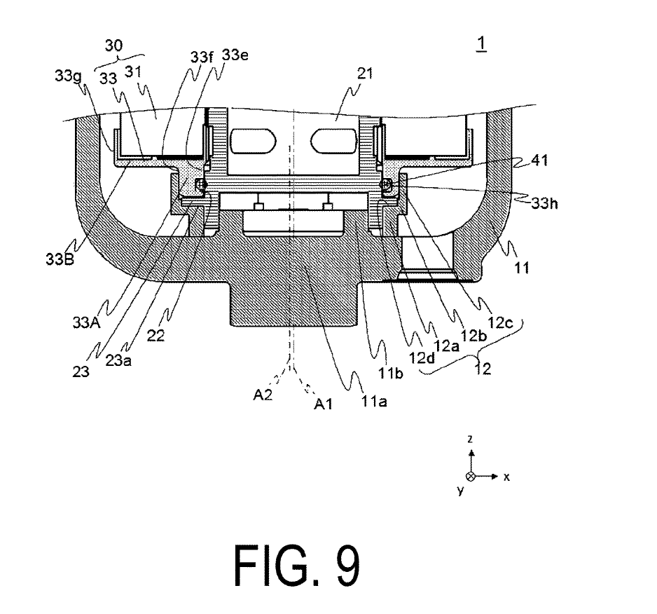

Next, the assembly and action of the filter device 1 thus configured will be described. FIGS. 8 and 9 are enlarged cross-sectional views of a portion (in the vicinity of the bottom surface 11a) of the filter device 1 in which the inner tube 20 and the filter element 30 are attached to the case assembly 10. FIG. 8 is a cross-sectional view in the xz plane, and FIG. 9 is a cross-sectional view in the yz plane.

First, the inner tube 20 is moved downward (in the −z direction) to be inserted between the receiving part 11b and the receiving part 12. Accordingly, the cylindrical portion 24 is inserted along the receiving part 11b and the tube portion 12a, the plate portion 25 is inserted along the flat surface 11e, and the claws 11c lock into the hole 26. In this way, the inner tube 20 is attached to and integrated with the case 11, that is, the case assembly 10.

The claws 11c each have a substantially triangular shape having the flat surface 11d on the −z side. Thus, when the inner tube 20 is inserted between the receiving part 11b and the receiving part 12, the claws 11c naturally lock into the hole 26.

When the claws 11c lock into the hole 26, the hole 26 comes into contact with the flat surface 11d. Thus, even in a case where force is applied to the inner tube 20 in the +z direction, the inner tube 20 is prevented from being removed from the case 11.

The flange portion 12b is positioned higher than the claws 11c. Thus, the claws 11c are covered by the tube portion 12a and the flange portion 12b. The claws 11c and the hole 26 are protected in this way, so that the claws 11c cannot be removed from the hole 26 by, for example, pressing the claws 11c with a tool or the like. This can prevent the inner tube 20 from being removed from the case 11.

With the inner tube 20 attached to the case 11, the outer surface of the flat surface 11e comes into contact with the inner surface of the plate portion 25 (see FIG. 8), and the outer peripheral surface of the cylindrical portion 24 comes into contact with the inner peripheral surface of the tube portion 12a (see FIG. 9).

Next, the filter element 30 is inserted along the inner tube 20. The filter element 30 is rotated so that the protrusions 21a, 21b, 21c, 21d lock into the recessed portions 32a. 32b, 32c, 32d. When the protrusions 21a, 21b, 21c, 21d lock into the recessed portions 32a, 32b, 32c, 32d, the filter element 30 is moved downward (in the −z direction). At this time, the inner tube 20 is inserted on the inner side of the filtration material 31 and the lower end member 33. The filter element 30 is moved downward until the bottom surface 23a of the flange portion 23 comes into contact with the recessed portion 12d.

When the filter element 30 is moved downward, the protrusions 21a, 21b, 21c, 21d lock into the recessed portions 33a, 33b, 33c, 33d, and the rib 33A is inserted between the tube portion 12c and the cylindrical portion 22. The protrusions 21a, 21b, 21c, 21d, the recessed portions 32a, 32b, 32c, 32d, and the recessed portions 33a, 33b, 33c, 33d are used in this way to position the filter element 30 relative to the inner tube 20. At this time, the inner peripheral surface 33e of the rib 33A is inserted along the outer peripheral surface of the cylindrical portion 22 and that the outer peripheral surface 33f of the rib 33A is inserted along the inner peripheral surface of the tube portion 12c.

The protrusion 21d and the recessed portions 32d, 33d are formed on the line x2 turned about the center axis A1 from the line x1 by the angle θ. However, since the angle θ is small, it is difficult to understand that the protrusion 21d and the recessed portions 32d, 33d are formed on the line x2. Thus, an imitation in which the protrusion 21d and the recessed portions 32d, 33d are formed on the line x1 can be prevented from being attached to the inner tube 20.

When the filter element 30 is placed on the inner tube 20, the inner tube 20 is positioned along the inner peripheral surface of the filtration material 31.

The inner peripheral surface 33e of the rib 33A is provided with a recessed portion 33h, and the recessed portion 33 h is provided with a sealing member 41. Thus, when the rib 33A is inserted between the tube portion 12c and the cylindrical portion 22, the sealing member 41 is elastically deformed by the cylindrical portion 22, resulting in prevention of leakage of liquid from between the inner tube 20 and the lower end member 33 before filtration.

The centers of the inner tube 20 and the inner peripheral surface 33e of the rib 33A coincide with the center axis A1, whereas the centers of the outer peripheral surface 33f of the rib 33A and the tube portion 12c coincide with the center axis A2. Thus, in a case where a position is incorrect in the rotational position, the lower end member 33 cannot be inserted into the tube portion 12c. However, the protrusions 21a, 21b, 21c, 21d, the recessed portions 32a, 32b, 32c, 32d, and the recessed portions 33a, 33b, 33c, 33d are used to position the filter element 30 relative to the inner tube 20, so that the rib 33A can be reliably inserted between the tube portion 12c and the cylindrical portion 22.

The action of the filter device 1 thus assembled will be described with reference to FIG. 1. The arrows in FIG. 1 indicate the flow of liquid in the filter device 1. The liquid before filtration flows from an inflow portion (not illustrated) into a space between the case assembly 10 and the filter element 30, is filtered by the filter element 30, and flows through the holes 20a into the inner tube 20. The filtered liquid flows from the inside of the inner tube 20 through an outflow portion (not illustrated) to the outside of the filter device 1.

According to the present embodiment, the claws 11c are used to integrate the inner tube 20 with the case 11. Thus, the inner tube 20 can be easily attached to the case 11 and can be prevented from being removed from the case 11. In a case where the inner tube 20 is removed from the case 11, for example, liquid before filtration and filtered liquid mix together, and the filter device 1 cannot exhibit its function. However, since the inner tube 20 is prevented from being removed, such a problem can be prevented.

According to the present embodiment, the protrusions 21a, 21b, 21c, 21d, the recessed portions 32a, 32b, 32c, 32d, and the recessed portions 33a, 33b, 33c, 33d provide effect of positioning in the rotational direction and effect of preventing an imitation from being attached. For example, since the inner tube 20 is provided with the protrusions 21a, 21b, 21c, 21d, a filter element in which no recessed portion 32a, 32b, 32c, 32d or recessed portion 33a, 33b, 33c, 33d is formed is prevented from being attached.

According to the present embodiment, the position of the center axis A2 of the tube portion 12c and the outer peripheral surfaces 33f, 33g of the lower end member 33 differs from the position of the center axis A1 of the inner tube 20. This configuration can prevent attachment of a filter element including a lower end member having an outer peripheral surface not offset from the center axis A1 of the inner tube 20. Effect of preventing an imitation from being attached can be further enhanced by performing both locking of the protrusions 21a, 21b. 21c, 21d into the recessed portions 32a, 32b, 32c, 32d and the recessed portions 33a. 33b, 33c, 33d and shifting in position of the center axis A1 and the center axis A2.

Note that in the present embodiment, the protrusions 21a, 21b, 21c, 21d, the recessed portions 32a, 32b, 32c, 32d, and the recessed portions 33a, 33b, 33c, 33d have substantially arcuate shapes; however, no such limitation is intended for the shapes of the protrusions 21a, 21b, 21 c, 21d, the recessed portions 32a, 32b, 32c, 32d, and the recessed portions 33a, 33b, 33c, 33d. The direction and position in shifting the center axis A2 with respect to the center axis A1 are not limited to those described in the present embodiment.

In the present embodiment, the inner tube 20 is attached to the case 11 by inserting the cylindrical portion 24 and the plate portion 25 along the receiving part 11b and the tube portion 12a and locking the claws 11c into the hole 26. However, the position, size, shape, and the like of the claws 11c are not limited to those described in the present embodiment. For example, claws protruding inward may be formed on the inner peripheral surface of the receiving part 11b, the inner tube 20 may be provided with a tube portion coming into contact with the inner peripheral surface of the receiving part 11b, and the tube portion may be provided with a hole for locking the claws thereinto.

### Second Embodiment

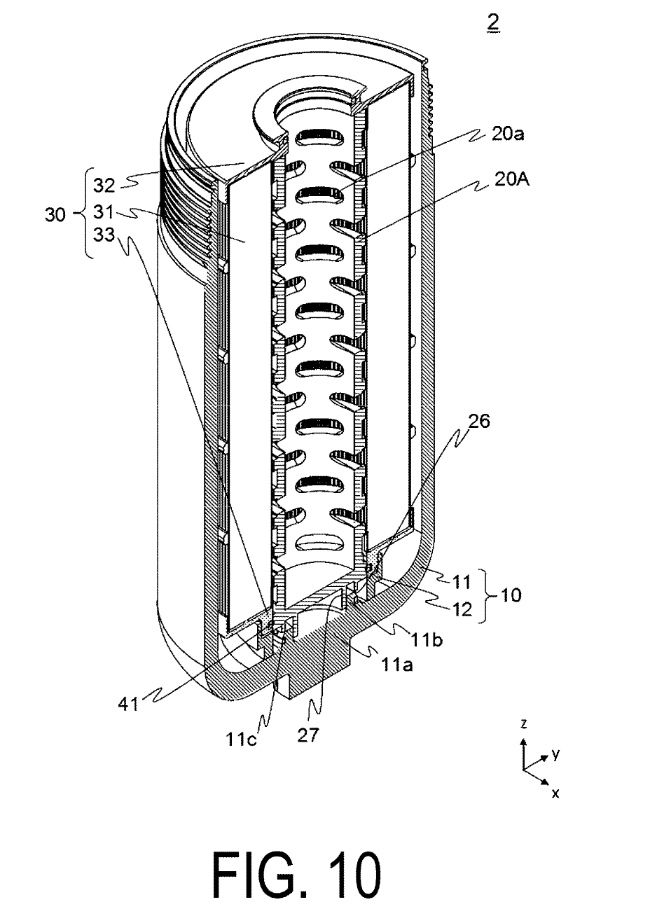

In the first embodiment of the present invention, when the inner tube 20 is attached to the case 11, the cylindrical portion 24 is inserted along the receiving part 11b and the tube portion 12a, that is, the ribs formed on the case 11 sandwich the inner tube 20. However, the method of attaching the inner tube 20 to the case 11 is not limited to this method. FIG. 10 is a perspective view illustrating an overview of a filter device 2 according to a modified example. The filter device 2 has the same configuration as that of the filter device 1, except in the shape of the inner tube. The same components are denoted using the same reference signs, and descriptions thereof will be omitted.

The filter device 2 mainly includes the case assembly 10, an inner tube 20A, and the filter element 30. In FIG. 10, the filter device 2 is cut along the yz plane for description.

The inner tube 20A has a substantially cylindrical shape as a whole and mainly includes the main body portion 21, the cylindrical portion 22, the flange portion 23, the cylindrical portion 24, the plate portion 25, the hole 26, and a cylindrical portion 27.

Similar to the cylindrical portion 24, the cylindrical portion 27 has a substantially cylindrical shape and is formed protruding in the −z direction from the end surface of the flange portion 23. The cylindrical portion 27 has a diameter smaller than the diameter of the cylindrical portion 24.

Note that the size and shape of the cylindrical portion 27 is not limited to this configuration. For example, a portion of the cylindrical portion 27 in the circumferential direction may be cut.

The inner peripheral surface of the cylindrical portion 24 comes into contact with the outer peripheral surface of the receiving part 11b, and the outer peripheral surface of the cylindrical portion 27 comes into contact with the inner peripheral surface of the receiving part 11b. Thus, when the inner tube 20A is moved downward (in the −z direction), the cylindrical portion 24 is inserted between the receiving part 11b and the receiving part 12, and the receiving part 11b is inserted between the cylindrical portion 24 and the cylindrical portion 27. Thus, with the inner tube 20A attached to the case 11, the two ribs (cylindrical portion 24 and cylindrical portion 27) formed on the inner tube 20A sandwich the rib (receiving part 11b) of the case 11.

According to the present embodiment, when the inner tube 20A is attached to the case 11, providing the rib-like cylindrical portion 27 can reduce unsteadiness of the inner tube 20A and prevent the center axis of the inner tube 20A from being tilted. Since the cylindrical portion 24 and the cylindrical portion 27 sandwich the receiving part 11b, the receiving part 11b is prevented from breakage or deformation, resulting in increased strength of the attaching portion of the inner tube 20A.

Note that in the present embodiment, the cylindrical portion 27 having a substantially cylindrical shape is formed as a rib; however, no such limitation is intended for the configuration of the rib. For example, a plurality of bars protruding in the −z direction from the end surface of the flange portion 23 may be formed on the inner tube as ribs. The bars may have various shapes, such as round shapes and plate shapes. By the bars and the cylindrical portion 24 sandwiching the receiving part 11b, unsteadiness of the inner tube 20A can be reduced and strength of the attaching portion of the inner tube 20A can be increased.

Note that the case 11, the filter element 30, and the inner tubes 20, 20A may have substantially tube-like shapes but they need not have substantially cylindrical shapes.

Embodiments of the invention have been described in detail with reference to the drawings; however, specific configurations are not limited to the embodiments, and changes in the design or the like are also included within a scope which does not depart from the gist of the invention. For example, the above examples have been explained in detail in order to facilitate understanding of the present invention and are not necessarily limited to examples provided with the entirety of the configuration described above. In addition, a part of the configuration of an embodiment may be replaced with the configuration of another embodiment and the configuration of another embodiment may be added to, deleted from, or replaced with the configuration of an embodiment.

Further, in the present invention, “substantially/approximately” is a concept that includes variation or modification to the extent that sameness is not lost, and does not only mean strictly the same. For example, “substantially orthogonal” is not limited to being strictly orthogonal, and is a concept that includes an error of several degrees, for example. Further, simple expressions such as orthogonal, parallel, and matching are not to be understood as merely being strictly orthogonal, parallel, matching, and the like, and include being substantially parallel, substantially orthogonal, substantially matching, and the like.

Furthermore, the meaning of the term “in the vicinity” in the present invention includes a region of a range (which can be determined as desired) near a position serving as a reference. For example, “in the vicinity of the end” refers to a region of a range near the end, and is a concept indicating that the end may or may not be included.

### REFERENCE SIGNS LIST

1 Filter device
10 Case assembly
11 Case
11a Bottom surface
11b Receiving part
11c Claw
11d Flat surface
11e Flat surface
12 Receiving part
12a Tube portion
12b Flange portion
12c Tube portion
12d Recessed portion
20, 20A Inner tube
20a Hole
21 Main body portion
21a Protrusion
21b Protrusion
21c Protrusion
21d Protrusion
22 Cylindrical portion
23 Flange portion
23a Bottom surface
24 Cylindrical portion
25 Plate portion
26 Hole
27 Cylindrical portion
30 Filter element
31 Filtration material
32 Upper end member
32a Recessed portion
32b Recessed portion
32c Recessed portion
32d Recessed portion
33 Lower end member
33A Rib
33B Flange portion
33a Recessed portion
33b Recessed portion
33c Recessed portion
33d Recessed portion
33e Inner peripheral surface
33f Outer peripheral surface
33g Outer peripheral surface
33h Recessed portion
41 Sealing member

1. A filter device comprising:
a case having a bottomed substantially cylindrical shape;
an inner tube having a substantially cylindrical shape; and
a filter element comprising a filtration material having a substantially cylindrical shape and a first end member disposed at a first end of the filtration material;
the case having a bottom surface provided with a first receiving part and a second receiving part, the first receiving part having a substantially cylindrical shape and being provided with claws, the second receiving part being formed outside the first receiving part;
the inner tube being provided with a hole for locking the claws into the hole;
upon insertion of the inner tube into the case, the first receiving part being inserted along the inner tube, and the claws locking into the hole, such that the inner tube is attached to the case; and
upon insertion of the filter element into the case, the inner tube being inserted along inner peripheral surfaces of the filtration material and the first end member, and the first end member being inserted between the second receiving part and the inner tube.

2. The filter device according to claim 1, wherein:
the claws are formed protruding outward in a radial direction;
the second receiving part comprises a first tube portion, a flange portion, and a second tube portion, the first tube portion being formed outside the first receiving part, having a diameter greater than a diameter of the first receiving part, and being higher than the first receiving part, the flange portion having a substantially circular plate shape and being formed at an end, of the first tube portion, on a side opposite to a side coming into contact with the bottom surface of the case, the second tube portion being formed along an outer peripheral surface of the flange portion, protruding toward a side where the first tube portion is not formed, and having a diameter greater than the diameter of the first tube portion;
the inner tube is inserted between the first receiving part and the first tube portion; and
the first end member is inserted along an inner peripheral surface of the second tube portion.

3. The filter device according to claim 1, wherein:
the filter element comprises a second end member disposed at a second end of the filtration material, the second end being an end other than the first end;
the inner tube has an outer peripheral surface provided with protrusions formed in a longitudinal direction, the protrusions protruding outward in the radial direction; and
the first end member and the second end member are each provided with recessed portions for locking the protrusions into the recessed portions.

4. The filter device according to claim 3, wherein:
the protrusions comprise, in a plane orthogonal to a center axis of the inner tube:
two first protrusions formed on a first line passing through the center axis of the inner tube, the first protrusions facing each other across the center axis of the inner tube;
a second protrusion formed on a second line passing through the center axis of the inner tube, the second line being orthogonal to the first line; and
a third protrusion formed on a third line turned about the center axis of the inner tube from the second line by a first angle, the third protrusion facing the second protrusion across the center axis of the inner tube.

5. The filter device according to claim 1, wherein a center axis of the first end member and the second tube portion is shifted in position in a radial direction with respect to the center axis of the inner tube and the first tube portion.

6. The filter device according to claim 2, wherein:
the filter element comprises a second end member disposed at a second end of the filtration material, the second end being an end other than the first end;
the inner tube has an outer peripheral surface provided with protrusions formed in a longitudinal direction, the protrusions protruding outward in the radial direction; and
the first end member and the second end member are each provided with recessed portions for locking the protrusions into the recessed portions.

7. The filter device according to claim 2, wherein a center axis of the first end member and the second tube portion is shifted in position in a radial direction with respect to the center axis of the inner tube and the first tube portion.

8. The filter device according to claim 3, wherein a center axis of the first end member and the second tube portion is shifted in position in a radial direction with respect to the center axis of the inner tube and the first tube portion.

9. The filter device according to claim 4, wherein a center axis of the first end member and the second tube portion is shifted in position in a radial direction with respect to the center axis of the inner tube and the first tube portion.

10. The filter device according to claim 6, wherein a center axis of the first end member and the second tube portion is shifted in position in a radial direction with respect to the center axis of the inner tube and the first tube portion.
